(19) United States
(12) Patent Application Publication
(10) Pub. No.: US 2017/0091431 A1
(43) Pub. Date: Mar. 30, 2017

(54) SECURE IDENTIFICATION INFORMATION ENTRY ON A SMALL TOUCHSCREEN DISPLAY

(71) Applicant: QUALCOMM Incorporated, San Diego, CA (US)

(72) Inventors: Bjorn Jakobsson, Portola Valley, CA (US); Wilson Kwan, Toronto (CA)

(21) Appl. No.: 14/866,899

(22) Filed: Sep. 26, 2015

(51) Int. Cl. G06F 21/31; G06F 21/60; G06F 3/0488; G06F 3/041; G06F 3/0481

(52) U.S. Cl. CPC G06F 21/31; G06F 3/0416; G06F 3/04817; G06F 3/04883; G06F 21/604

(57) ABSTRACT

System, methods, and apparatus are described that facilitate secure identification information entry on a small touchscreen display. In an example, the apparatus receives an account identifier of a user, determines a first starting configuration associated with the account identifier, the first starting configuration being independent of a second starting configuration associated with a different account identifier, and displays one or more data input components for entry of at least a portion of secure identification information on a touchscreen display according to the determined first starting configuration.

### BACKGROUND

Field

The present disclosure pertains to secure identification information entry on a small touchscreen display.

Background

Touchscreen displays are increasingly being implemented in various types of electronic devices (e.g., smartphones, tablets, smartwatches, etc.). Generally, a touchscreen display enables a user to control the electronic device and/or enter data. For example, an electronic device may enable data entry by displaying a keypad on the touchscreen display and by receiving touch inputs on the keypad from the user. However, in certain applications where the data to be entered is secure identification information (e.g., a PIN for a banking application or a security code for accessing the electronic device), the use of the same keypad may compromise the security of the secure identification information entered by the user (e.g., due to a potential phishing attack). Moreover, several applications (e.g., smartwatches) may involve the use of small touchscreen displays. The smaller area of such touchscreen displays typically result in correspondingly smaller input regions (e.g., keys, buttons, icons, etc.), which make it difficult for a user to efficiently and accurately input data using touch inputs (e.g., gestures performed on the touchscreen display). For example, due to the smaller input regions, the user's finger may inadvertently contact a key or button other than an intended key or button. This may cause frustration and result in a negative user experience. Therefore, more efficient and/or secure approaches for data entry on small touchscreen displays are needed.

### SUMMARY

The aspects disclosed herein provide systems, methods and apparatus for secure identification information entry on a small touchscreen display.

According to one aspect, a method for an electronic device includes receiving an account identifier of a user and determining a first starting configuration associated with the account identifier. The first starting configuration is independent of a second starting configuration associated with a different account identifier. In an aspect, the first starting configuration is different from the second starting configuration. The method further includes displaying one or more data input components for entry of at least a portion of secure identification information on a touchscreen display according to the determined first starting configuration. In an aspect, each of the one or more data input components may include a number of user selectable elements in a circular arrangement. For example, each of the number of user selectable elements may represent an alphanumeric character, a pattern, a picture, a glyph, or a color. For example, the number of user selectable elements may represent a first sequence of numbers or letters that increases in a clockwise direction, or a second sequence of numbers or letters that decreases in the clockwise direction.

In an aspect, the method further includes receiving a first input from the user at a center of the touchscreen display, receiving a second input for selecting a user selectable element from among the plurality of user selectable elements, the second input including a dragging motion from the center of the touchscreen display to the user selectable element, emphasizing the selected user selectable element on the touchscreen display, and entering a value represented by the selected user selectable element when a third input is received from the user. In an aspect, the method further includes deselecting the selected user selectable element when the third input is not received from the user. In an aspect, the emphasizing the selected user selectable element on the touchscreen display includes at least one of enlarging a size of the selected user selectable element, changing a color or a background of the selected user selectable element, changing a representation of the selected user selectable element, providing an audible feedback associated with the selected user selectable element, or providing a tactile feedback associated with the selected user selectable element.

In an aspect, the method further includes randomly reconfiguring the one or more data input components displayed on the touchscreen display after each value of the secure identification information is entered.

According to another aspect, a method for an electronic device includes receiving an account identifier of a user and determining a first starting configuration associated with the account identifier. The first starting configuration is independent of a second starting configuration associated with a different account identifier. In an aspect, the first starting configuration is different from the second starting configuration. The method further includes displaying one or more data input components for entry of at least a portion of secure identification information on a touchscreen display according to the determined first starting configuration. In an aspect, each of the one or more data input components may include a number of user selectable elements in a circular arrangement. For example, each of the number of user selectable elements may represent an alphanumeric character, a pattern, a picture, a glyph, or a color. For example, the number of user selectable elements may represent a first sequence of numbers or letters that increases in a clockwise direction, or a second sequence of numbers or letters that decreases in the clockwise direction.

In an aspect, the method further includes receiving a first input from the user for selecting a user selectable element from among the number of user selectable elements, the first input including a touch input on or near the selected user selectable element, emphasizing the selected user selectable element on the touchscreen display, and entering a value represented by the selected user selectable element when a second input is received from the user.

In an aspect, the emphasizing the selected user selectable element on the touchscreen display includes at least one of enlarging a size of the selected user selectable element, changing a color or a background of the selected user selectable element, changing a representation of the selected user selectable element, providing an audible feedback associated with the selected user selectable element, or providing a tactile feedback associated with the selected user selectable element.

In an aspect, the method further includes deselecting the selected user selectable element when a third input is received from the user. In an aspect, the method further includes randomly reconfiguring the one or more data input components displayed on the touchscreen display after each value of the secure identification information is entered.

According to another aspect, a method for an electronic device includes receiving an account identifier of a user and determining a first starting configuration associated with the account identifier. The first starting configuration is independent of a second starting configuration associated with a different account identifier. In an aspect, the first starting configuration is different from the second starting configuration. The method further includes displaying one or more data input components for entry of at least a portion of secure identification information on a touchscreen display according to the determined first starting configuration.

In an aspect, the method further includes receiving a first input from the user for selecting a data input component from among the one or more data input components, the data input component having a plurality of user selectable states, emphasizing the selected data input component on the touchscreen display, and receiving a second input from the user for modifying a state of the selected data input component. In an aspect, each of the user selectable states may represent an alphanumeric character, a pattern, a picture, a glyph, or a color.

In an aspect, the method further includes receiving a third input from the user for selecting a different data input component displayed on the touchscreen display, emphasizing the selected different data input component on the touchscreen display, and receiving a fourth input from the user for modifying a state of the selected different data input component. In an aspect, the first and third inputs may be a swiping gesture in a first direction or a tilting motion in the first direction, and the second and fourth inputs may be a swiping gesture in a second direction or a tilting motion in the second direction, where the first direction is different from the second direction.

### DRAWINGS

Various features, nature and advantages may become apparent from the detailed description set forth below when taken in conjunction with the drawings in which like reference characters identify correspondingly throughout.

FIG. 1 (including FIGS. 1A to 1I) illustrates an exemplary approach for entering secure identification information using a touchscreen display of an electronic device in accordance with various aspects of the disclosure.

FIG. 2 (including FIGS. 2A to 2K) illustrates an exemplary approach for entering secure identification information using a touchscreen display of an electronic device in accordance with various aspects of the disclosure.

FIG. 3 (including FIGS. 3A and 3B) illustrates an exemplary approach for performing a delete operation using a touchscreen display of an electronic device in accordance with various aspects of the disclosure.

FIG. 4 (including FIGS. 4A and 4B) illustrates an exemplary approach for performing a delete operation using a touchscreen display of an electronic device in accordance with various aspects of the disclosure.

FIG. 5 (including FIGS. 5A and 5B) illustrates an exemplary electronic device in accordance with various aspects of the disclosure.

FIG. 6 (including FIGS. 6A to 6E) illustrates an exemplary approach for entering secure identification information using a touchscreen display of an electronic device in accordance with various aspects of the disclosure.

FIG. 7 (including FIGS. 7A and 7B) illustrates an exemplary electronic device in accordance with various aspects of the disclosure.

FIG. 8 is an illustration of an apparatus configured to support operations related to secure identification information entry on a small touchscreen display according to one or more aspects of the disclosure.

FIG. 9 is a flowchart illustrating a method of secure identification information entry on a small touchscreen display in accordance with various aspects of the disclosure.

FIG. 10 is a flowchart illustrating a method of secure identification information entry on a small touchscreen display in accordance with various aspects of the disclosure.

FIG. 11 is a flowchart illustrating a method of secure identification information entry on a small touchscreen display in accordance with various aspects of the disclosure.

### DETAILED DESCRIPTION

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures and techniques may not be shown in detail in order not to obscure the embodiments.

### First Exemplary Approach for Entering Secure Identification Information—Circular Arrangement of User Selectable Elements

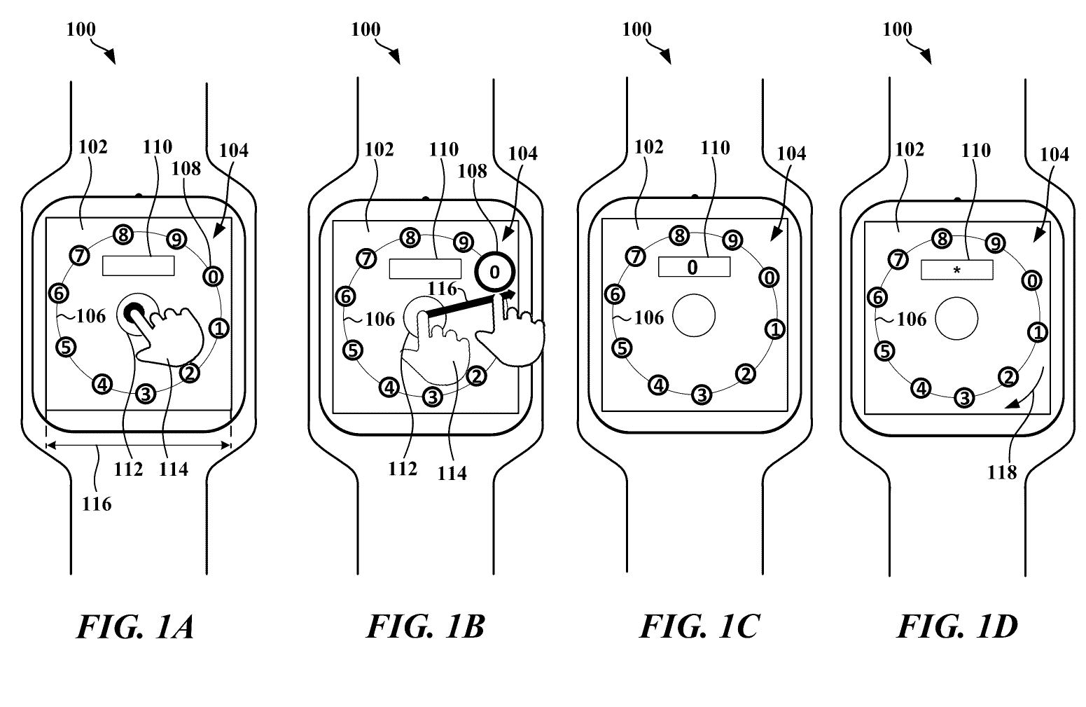

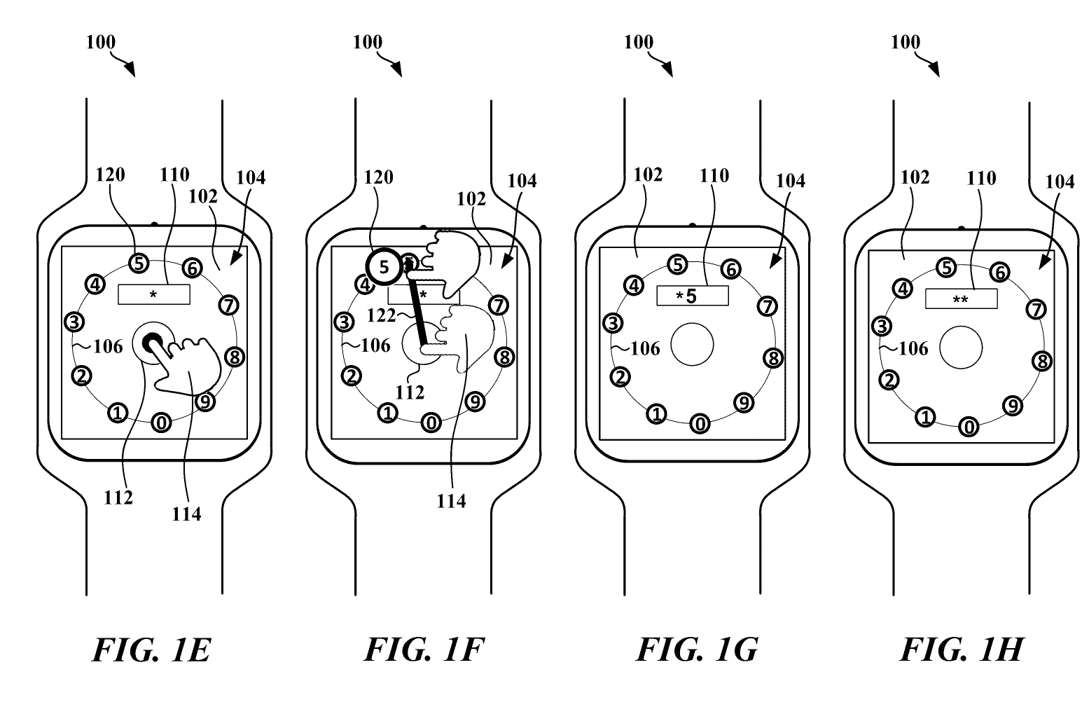

FIG. 1 (including FIGS. 1A to 1I) illustrates an exemplary approach for entering secure identification information, such as a personal identification number (PIN), using a touchscreen display of an electronic device 100. As shown in FIG. 1, electronic device 100 includes a touchscreen display 102 configured to display a data entry interface 104. The touchscreen display 102 of electronic device 100 may be relatively small. For example, as shown in the aspect of FIG. 1, the electronic device 100 may be a smartwatch. In such example, the shape of the touchscreen display 102 may be a square and the length (e.g., length 116) of each side of the touchscreen display 102 may be one inch. It should be understood, however, that the electronic device 100 may be a different type of electronic device, such as a portable media player (e.g., MP3 player), in other aspects.

In FIG. 1A, data entry interface 104 includes a data input component 106, a data window 110, and a button 112. As shown in FIG. 1A, the data input component 106 includes a number of user selectable elements, such as the user selectable element 108 representing the number zero, arranged in a circular pattern. In an aspect, each of the user selectable elements may represent an alphanumeric character, a pattern, a picture, a glyph, or a color. In the aspect of FIG. 1A, for example, the user selectable elements of data input component 106 represent a sequence of the numbers zero through nine in the clockwise direction. The configuration of the data input component 106 shown in FIG. 1A may be referred to as a starting configuration. As described below, a user 114 may enter secure identification information using the data input component 106 of the data entry interface 104 by performing various gestures on the touchscreen display 102.

In one example, the user 114 may use the data input component 106 to enter secure identification information, such as a four digit PIN “0518”. As shown in FIG. 1A, the user 114 may provide a first input by using her finger to touch the button 112 displayed on the center of the touchscreen display 102. As shown in FIG. 1B, in order to enter the first number (e.g., zero) of the exemplary PIN “0518”, the user 114 may provide a second input by dragging her finger from the button 112 along the direction of arrow 116 toward the user selectable element 108 representing the number zero. As the user 114 approaches the user selectable element 108, the electronic device 100 may emphasize the user selectable element 108 by enlarging the size of the user selectable element 108 as shown in FIG. 1B. In other aspects, the electronic device 100 may emphasize the user selectable element 108 by changing a color or a background of the user selectable element 108, changing a representation of the user selectable element 108, providing an audible feedback associated with the user selectable element 108, and/or providing a tactile feedback associated with the user selectable element 108. The emphasizing (e.g., enlargement) of the user selectable element 108 may serve as an indication to the user 114 that user selectable element 108 is currently selected. If the emphasized user selectable element (e.g., user selectable element 108) is the user selectable element intended by the user 114, the user 114 may execute the selection by providing a third input. For example, the user may provide the third input by lifting her finger to no longer make contact with the touchscreen display 102. As shown in FIG. 1C, after the user 114 has lifted her finger from the touchscreen display 102, the number (e.g., zero) represented by the user selectable element 108 may be displayed momentarily (e.g., approximately one second) in the data window 110. In order to preserve the security of the number (e.g., zero) selected by the user 114, the electronic device 100 may display a placeholder symbol (e.g., an asterisk) in the data window 110 instead of the number selected by the user 114 as shown in FIG. 1D.

In an aspect, after the user 114 has entered the first number (e.g., zero) of the exemplary PIN “0518”, the electronic device 100 may reconfigure the data input component 106. In one aspect, the electronic device 100 may reconfigure the data input component 106 shown in FIG. 1D by randomly rotating the data input component 106 in a clockwise direction 118. In another aspect, the electronic device 100 may reconfigure the data input component 106 by randomly rotating the data input component 106 in a counterclockwise direction. In another aspect, the electronic device 100 may reconfigure the data input component 106 by reversing the sequence of the numbers represented by the user selectable elements. It can be appreciated that the reconfiguration of the data input component 106 may not cause a substantial disruption to the user 114 when entering the secure identification information, because the values represented by the user selectable elements of the data input component 106 still maintain a sequence. Therefore, the user 114 may quickly locate a desired user selectable element despite the reconfiguration of the data input component 106.

After the data input component 106 has been reconfigured (e.g., randomly rotated in a clockwise direction) as shown in FIG. 1E, the user 114 may proceed to enter the second number (e.g., five) of the exemplary PIN “0518” in a manner similar to first number as previously discussed with respect to FIGS. 1A and 1B. For example, with reference to FIG. 1E, the user 114 may use her finger to touch the button 112 displayed at the center of the touchscreen display 102. As shown in FIG. 1F, in order to enter the second number (e.g., five), the user 114 may drag her finger from the button 112 along the direction of arrow 122 toward the user selectable element 120 representing the number five. As the user 114 approaches the user selectable element 120, the electronic device 100 may emphasize (e.g., enlarge) the user selectable element 120 as shown in FIG. 1F. Such emphasizing (e.g., enlargement) of the user selectable element 120 may serve as an indication to the user 114 that the user selectable element 120 is currently selected. If the emphasized (e.g., enlarged) user selectable element (e.g., user selectable element 120) is the user selectable element intended by the user 114, the user 114 may execute the selection by lifting her finger to no longer make contact with the touchscreen display 102. As shown in FIG. 1G, after the user 114 has lifted her finger from the touchscreen display 102, the number (e.g., five) represented by the user selectable element 120 may be displayed momentarily (e.g., approximately one second) in the data window 110. In order to preserve the security of the number (e.g., five) selected by the user 114, the electronic device 100 may display a placeholder symbol (e.g., an asterisk) in the data window 110 instead of the number selected by the user 114 as shown in FIG. 1H. The user 114 may continue to enter the remaining numbers of the exemplary PIN “0518” in a manner similar to the first and second numbers as previously described.

With reference to FIG. 1I, when the user 114 has completed entering the exemplary PIN “0518” as indicated by the four placeholder symbols in data window 110, the user 114 may submit (e.g., enter) the entered PIN by double tapping the button 112 on the touchscreen display 102.

### Second Exemplary Approach for Entering Secure Identification Information—Circular Arrangement of User Selectable Elements

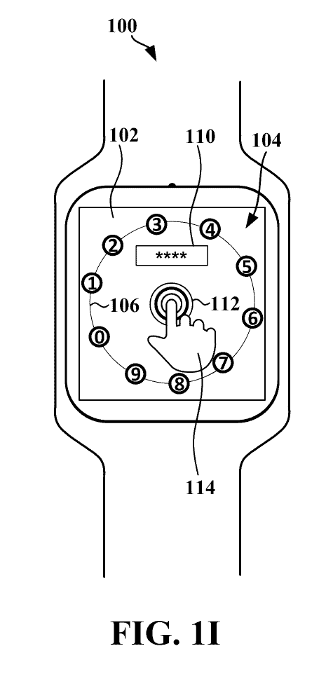

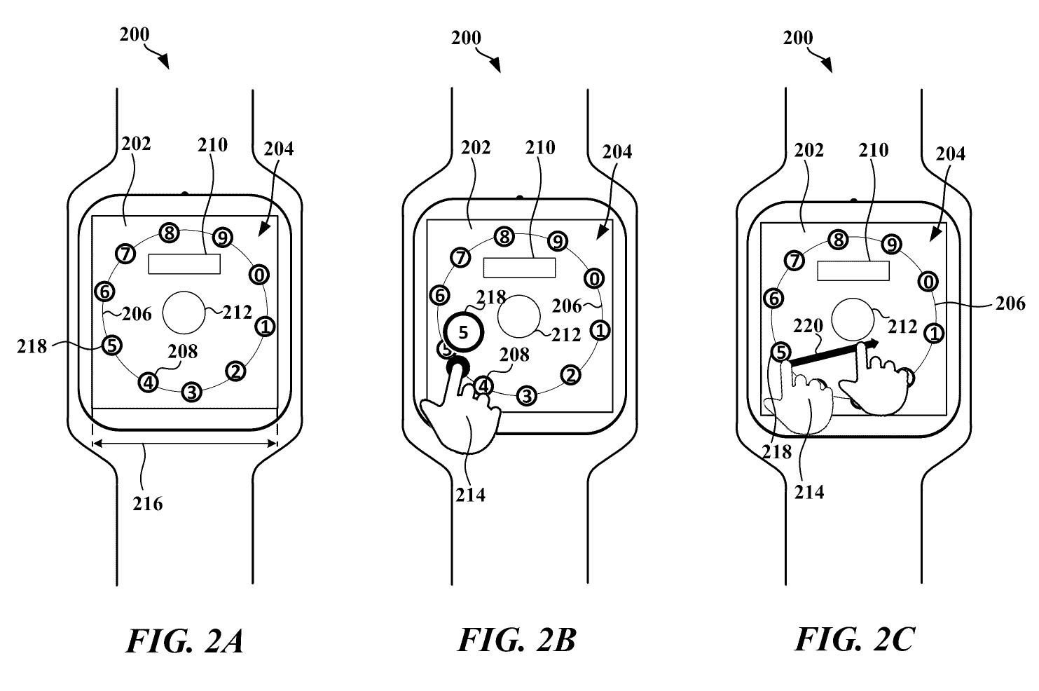

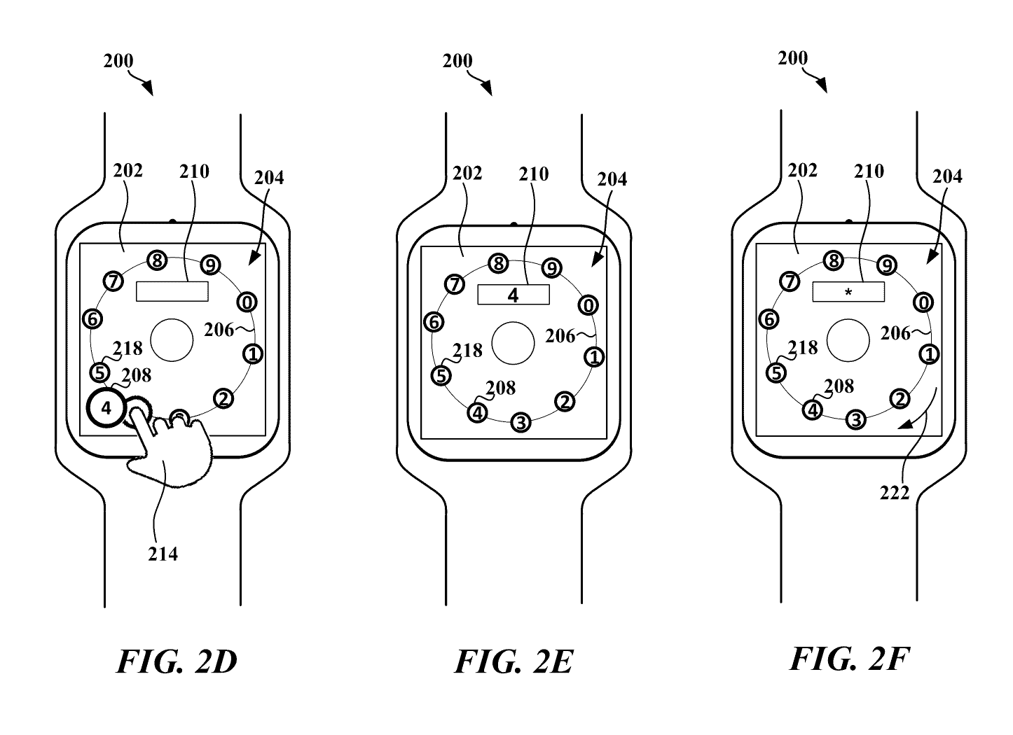

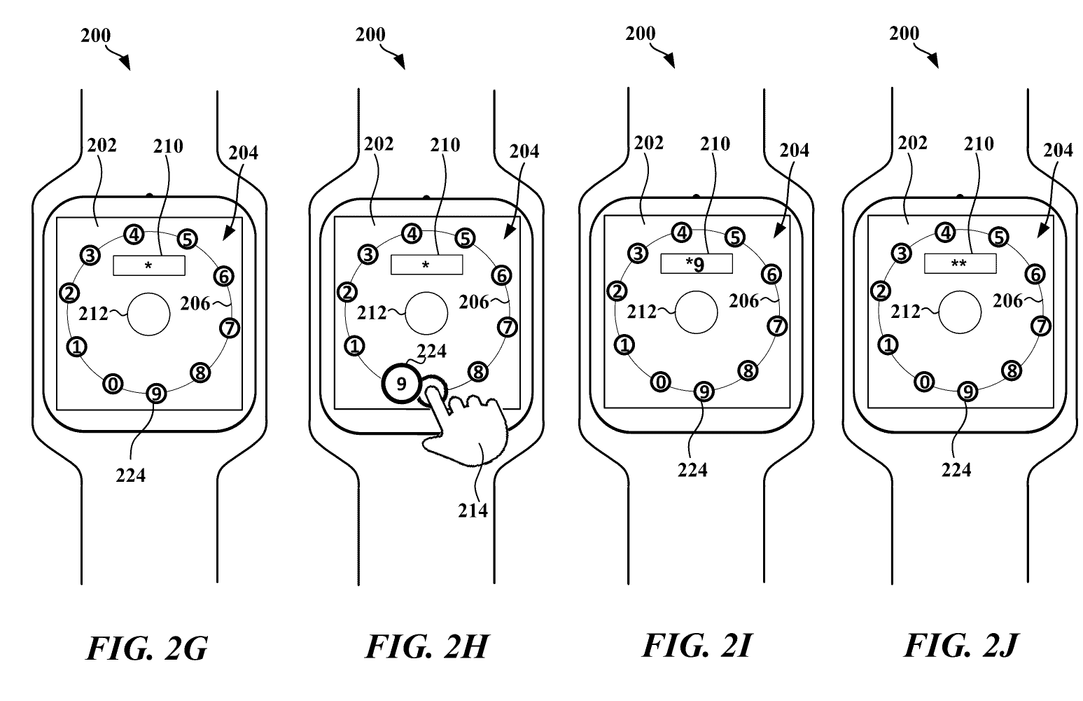

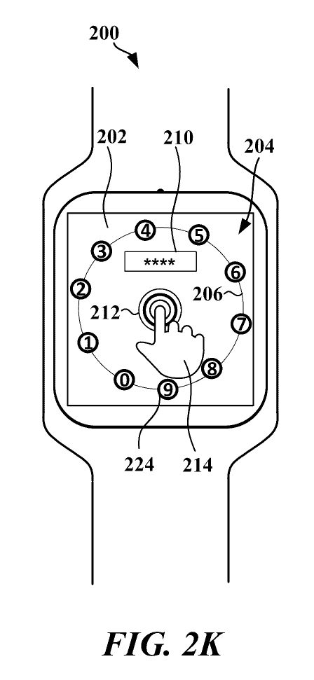

FIG. 2 (including FIGS. 2A to 2K) illustrates an exemplary approach for entering secure identification information, such as a PIN, using a touchscreen display of an electronic device 200. As shown in FIG. 2, electronic device 200 includes a touchscreen display 202 configured to display a data entry interface 204. The touchscreen display 202 of electronic device 200 may be relatively small. For example, as shown in the aspect of FIG. 2, the electronic device 200 may be a smartwatch. In such example, the shape of the touchscreen display 202 may be a square and the length (e.g., length 216) of each side of the touchscreen display 202 may be one inch. It should be understood, however, that the electronic device 200 may be a different type of electronic device, such as a portable media player (e.g., MP3 player), in other aspects.

In FIG. 2A, data entry interface 204 includes a data input component 206, a data window 210, and a button 212. As shown in FIG. 2A, the data input component 206 includes a number of user selectable elements, such as the user selectable element 208 representing the number four and the user selectable element 218 representing the number five, arranged in a circular pattern. In an aspect, each of the user selectable elements may represent an alphanumeric character, a pattern, a picture, a glyph, or a color. In the aspect of FIG. 2A, for example, the user selectable elements of data input component 206 represent a sequence of the numbers zero through nine in the clockwise direction. The configuration of the data input component 206 shown in FIG. 2A may be referred to as a starting configuration. As described below, a user 214 may enter secure identification information using the data input component 206 by performing various gestures on the touchscreen display 202.

In an aspect, a user 214 may use the data input component 206 to enter secure identification information, such as a four digit PIN “4937”. For example, in order to enter the first number (e.g., four) of the exemplary PIN “4937”, the user 214 may provide a first input by using her finger to touch and hold on the user selectable element 208 representing the number four on the touchscreen display 202. However, in the present example with reference to FIG. 2B, the user 214 has inadvertently touched an area on the touchscreen display 202 that is closer to the user selectable element 218 representing the number five. As shown in FIG. 2B, the electronic device 200 may emphasize the user selectable element 218 in response to the first input (e.g., touching and holding finger on the user selectable element 218) by enlarging the user selectable element 218. In other aspects, the electronic device 200 may emphasize the user selectable element 218 by changing a color or a background of the user selectable element 218, changing a representation of the user selectable element 218, providing an audible feedback associated with the user selectable element 218, and/or providing a tactile feedback associated with the user selectable element 218. The emphasizing (e.g., enlargement) of the user selectable element 218 may serve as an indication to the user 214 that user selectable element 218 is currently selected. Since the emphasized (e.g., enlarged) user selectable element 218 is not the user selectable element intended by the user 214, the user 214 may deselect the user selectable element 218 by dragging her finger toward the center (e.g., in the direction of arrow 220 toward the button 212) of the touchscreen display 202 as shown in FIG. 2C. Subsequently, and as shown in FIG. 2D, the user 214 may again try to provide the first input to select the user selectable element 208 representing the number four. For example, as shown in FIG. 2D, the user 214 may use her finger to touch and hold on the user selectable element 208 representing the number four on the touchscreen display 202. The electronic device 200 may then emphasize (e.g., enlarge) the user selectable element 208. If the emphasized (e.g., enlarged) user selectable element 208 is the user selectable element intended by the user 214, the user 214 may execute the selection by providing a second input. For example, the user 214 may provide the second input by lifting her finger to no longer make contact with the touchscreen display 202 or by tapping the user selectable element 208 on the touchscreen display 202. As shown in FIG. 2E, after the user 214 has provided the second input, the number (e.g., four) represented by the user selectable element 208 may be displayed momentarily (e.g., approximately one second) in the data window 210. In order to preserve the security of the number (e.g., four) selected by the user 214, the electronic device 200 may display a placeholder symbol (e.g., an asterisk) in the data window 210 instead of the number selected by the user 214 as shown in FIG. 2F.

In an aspect, after the user 214 has entered the first number (e.g., four) of the exemplary PIN “4937”, the electronic device 200 may reconfigure the data input component 206. In one aspect, the electronic device 200 may reconfigure the data input component 206 shown in FIG. 2F by randomly rotating the data input component 206 in a clockwise direction 222. After the data input component 206 has been rotated as shown in FIG. 2G, the user 214 may proceed to enter the second number (e.g., nine) of the exemplary PIN “4937” in a manner similar to the first number (e.g., four) as previously described. For example, with reference to FIG. 2H, in order to enter the second number (e.g., nine), the user 214 may use her finger to touch the user selectable element 224 representing the number nine. The electronic device 200 may emphasize (e.g., enlarge) the user selectable element 224 as shown in FIG. 2H. Such emphasizing (e.g., enlargement) of the user selectable element 224 may serve as an indication to the user 214 that user selectable element 224 is currently selected. If the emphasized (e.g., enlarged) user selectable element (e.g., user selectable element 224) is the user selectable element intended by the user 214, the user 214 may execute the selection by lifting her finger to no longer make contact with the touchscreen display 202. As shown in FIG. 2I, after the user 214 has lifted her finger from the touchscreen display 202, the number (e.g., nine) represented by the user selectable element 224 may be displayed momentarily (e.g., approximately one second) in the data window 210. In order to preserve the security of the number (e.g., nine) selected by the user 214, the electronic device 200 may display a placeholder symbol (e.g., an asterisk) in the data window 210 instead of the number selected by the user 214 as shown in FIG. 2J. The user 214 may continue to enter the remaining numbers of the exemplary PIN “4937” in a manner similar to the first and second numbers as previously described.

With reference to FIG. 2K, when the user 214 has completed entering the exemplary PIN “4937” as indicated by the four placeholder symbols in data window 210, the user 214 may submit (e.g., enter) the entered PIN by double tapping the button 212 on the touchscreen display 202.

### First Exemplary Approach for Performing a Delete Operation

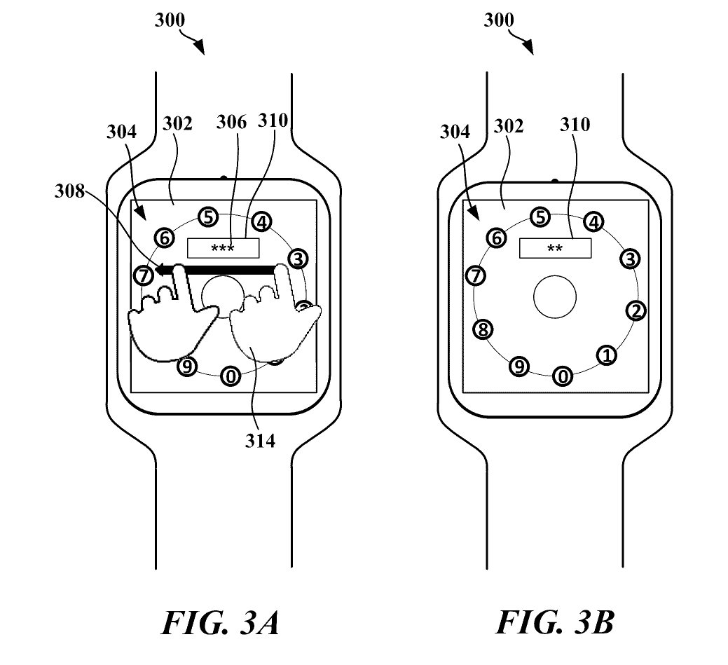

FIG. 3 (including FIGS. 3A and 3B) illustrates an exemplary approach for performing a delete operation using a touchscreen display of an electronic device 300 in accordance with various aspects of the disclosure. In an aspect, the electronic device 300 may correspond to the electronic device 100 in FIG. 1 or the electronic device 200 in FIG. 2. As shown in FIG. 3, electronic device 300 includes a touchscreen display 302 configured to display a data entry interface 304 similar to the previously discussed data entry interface 104 in FIG. 1 or the data entry interface 204 in FIG. 2. In the aspect of FIG. 3A, the user 314 has entered three values of secure identification information using the data entry interface 304, which are represented by the three asterisks in the data window 310. In an aspect, the user 314 may perform a delete operation to delete the latest entered value (e.g., represented by the asterisk 306) by using her finger to touch the touchscreen display 302 and performing a swiping gesture across the touchscreen display 302 in a horizontal direction (e.g., in the direction of the arrow 308) as shown in FIG. 3A. In response to the swiping gesture, the electronic device 300 may delete the latest value (e.g., represented by the asterisk 306) entered by the user 314 as shown in FIG. 3B. In an aspect, the user 312 may repeat the previously described swiping gesture to delete one or more of the remaining values in the data window 310.

### Second Exemplary Approach for Performing a Delete Operation

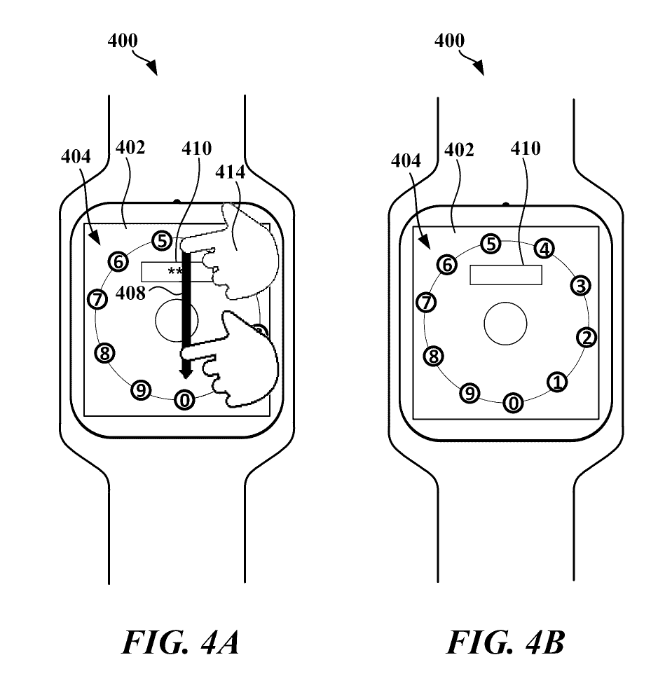

FIG. 4 (including FIGS. 4A and 4B) illustrates an exemplary approach for performing a delete operation using a touchscreen display of an electronic device 400 in accordance with various aspects of the disclosure. In an aspect, the electronic device 400 may correspond to the electronic device 100 in FIG. 1 or the electronic device 200 in FIG. 2. As shown in FIG. 4, electronic device 400 includes a touchscreen display 402 configured to display a data entry interface 404 similar to the previously discussed data entry interface 104 in FIG. 1 or the data entry interface 204 in FIG. 2. In the aspect of FIG. 4A, the user 414 has entered two values of secure identification information using the data entry interface 404, which are represented by the two asterisks in the data window 410. For example, the user 414 may perform a delete operation to delete all of the entered values by using her finger to touch the touchscreen display 402 and performing a swiping gesture across the touchscreen display 302 in a vertical direction (e.g., in the direction of the arrow 408) as shown in FIG. 4A. In response to the swiping gesture, the electronic device 400 may delete all of the values (e.g., represented by the asterisks in data window 410) entered by the user 314 as shown in FIG. 4B.

### Exemplary Starting Configurations of Data Input Components—Circular Arrangement of User Selectable Elements

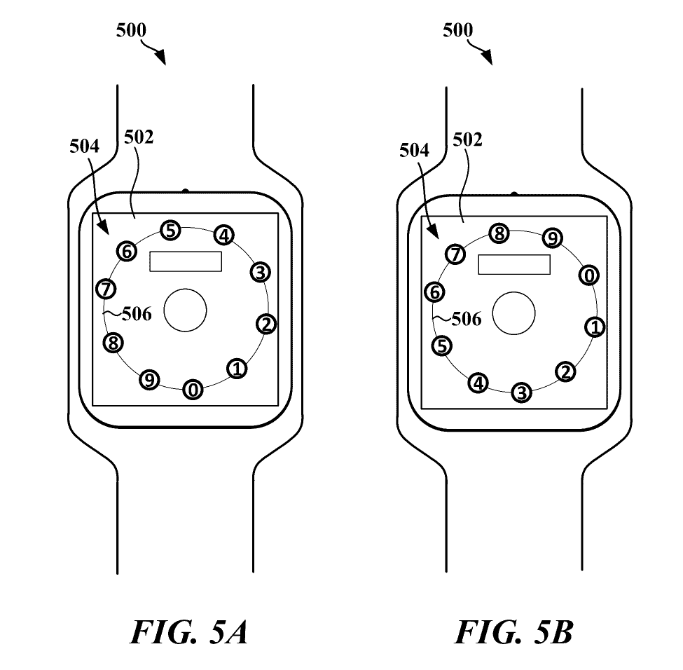

FIG. 5 (including FIGS. 5A and 5B) illustrates an exemplary electronic device 500 in accordance with various aspects of the disclosure. In an aspect, the electronic device 500 may correspond to the electronic device 100 in FIG. 1 or electronic device 200 in FIG. 2. As shown in FIG. 5, electronic device 500 includes a touchscreen display 502 configured to display a data entry interface 504 that may be similar in operation to the previously discussed data entry interface 104 in FIG. 1 or the data entry interface 204 in FIG. 2.

In an aspect, the electronic device 500 may display the data entry interface 504 for a first user according to a first starting configuration of the data input component 506 shown in FIG. 5A. In an aspect, the first starting configuration of the data input component 506 may be randomly generated by the electronic device 500 and may be associated with an account identifier of the first user. In such aspect, the electronic device 500 may receive a valid account identifier from the first user and may display the data input component 506 according to the first starting configuration shown in FIG. 5A every time the first user provides the valid account identifier. For example, the account identifier may be a username or an account number of the user. In an aspect, the first starting configuration may be independent of a second starting configuration associated with a different account identifier. For example, a second starting configuration of the data input component 506 shown in FIG. 5B may be randomly generated by the electronic device 500 and may be associated with an account identifier of a second user. In such aspect, the electronic device 500 may receive a valid account identifier from the second user and may display the data input component 508 according to the second starting configuration shown in FIG. 5B every time the second user provides the valid account identifier. In the aspect of FIG. 5, the first starting configuration of the data input component 506 shown in FIG. 5A is different from the second starting configuration of the data input component 506 shown in FIG. 5B. Therefore, by displaying a data input component according to different starting configurations for different users, phishing attacks may be avoided. In other words, the different starting configurations for different users make it difficult for unauthorized third parties to determine the values entered by each user. In other aspects, the first starting configuration of the data input component 506 shown in FIG. 5A may be the same as the second starting configuration of the data input component 506 shown in FIG. 5B.

### Third Exemplary Approach for Entering Secure Identification Information—Interactive Wheels

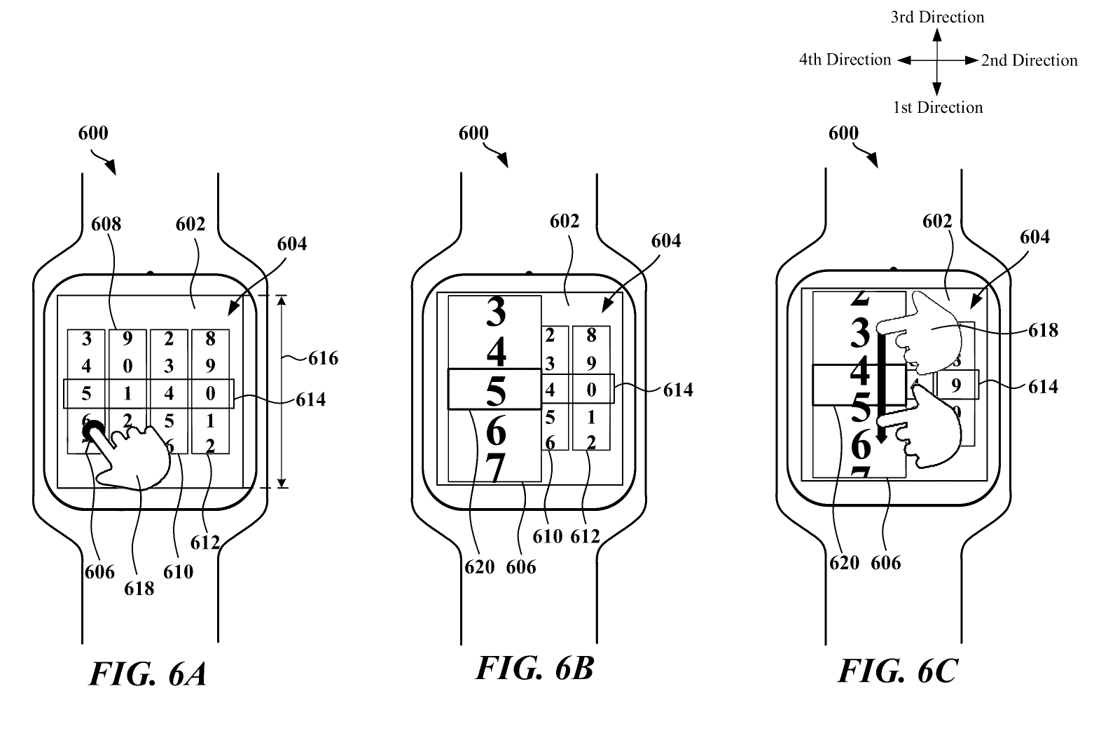

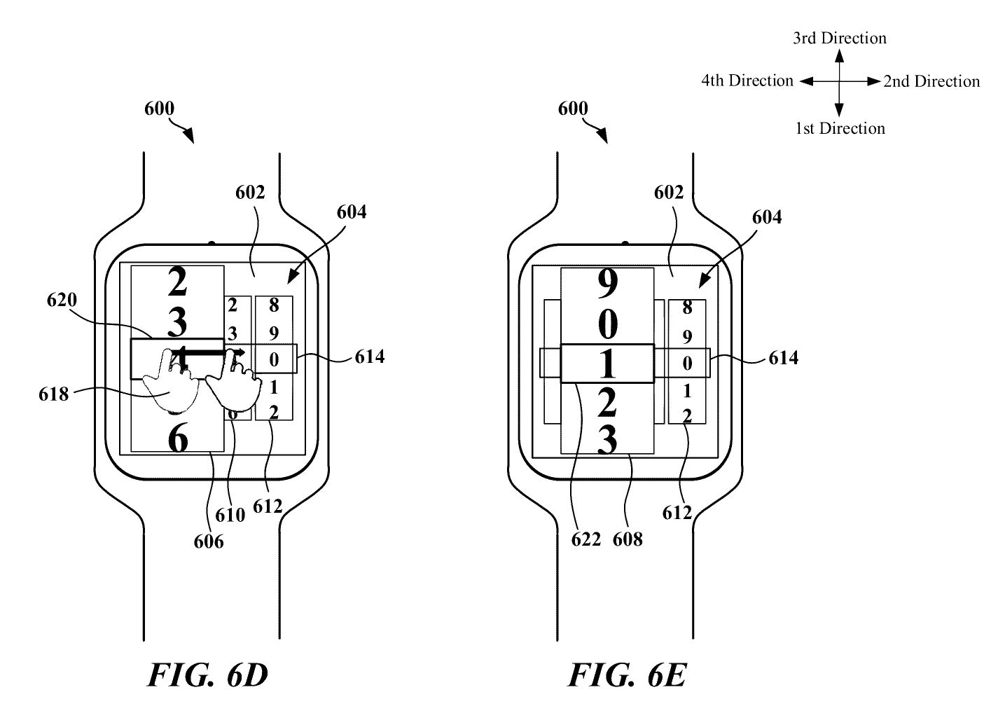

FIG. 6 (including FIGS. 6A to 6E) illustrates an exemplary approach for entering secure identification information, such as a PIN, using a touchscreen display of an electronic device 600. As shown in FIG. 6, electronic device 600 includes a touchscreen display 602 configured to display a data entry interface 604. The touchscreen display 602 of electronic device 600 may be relatively small. For example, as shown in the aspect of FIG. 6, the electronic device 600 may be a smartwatch. In such example, the shape of the touchscreen display 602 may be a square and the length (e.g., length 616) of each side of the touchscreen display 602 may be one inch. It should be understood, however, that the electronic device 600 may be a different type of electronic device, such as a portable media player (e.g., MP3 player), in other aspects.

With reference to FIG. 6A, data entry interface 604 includes a number of data input components, such as data input components 606, 608, 610, and 612. In the aspect of FIG. 6A, each of the data input components 606, 608, 610, and 612 includes a number of user selectable states. In an aspect, each of the user selectable states may represent an alphanumeric character, a pattern, a picture, a glyph, or a color. For example, the user selectable states of data input component 606 include the sequence of numbers zero through nine, of which three through seven currently appear on the touchscreen display 602 in FIG. 6A. In this example, the user selectable states of the other data input components 608, 610, and 612 also include the sequence of numbers zero through nine. As shown in FIG. 6A, the selected state of each data input component 606, 608, 610, and 612 appears in the data window 614. Therefore, as shown in FIG. 6A, the user selectable states of the data input components 606, 608, 610, and 612 are currently set to provide the number “5140” as indicated in the data window 614. In the aspect of FIG. 6A, and as described herein, each of the data input components 606, 608, 610, and 612 is configured as an interactive wheel that a user may scroll in order to set the desired user selectable state in the data window 614.

In one example, a user 618 may desire to set the state of the data input component 606 to the number four. In this example, the user 618 may provide a first input to select the data input component 606. In an aspect, the user 618 may provide the first input by touching the touchscreen display 602 on or near the data input component 606 as shown in FIG. 6A. In response to the first input, the electronic device 600 may emphasize (e.g., enlarge) the data input component 606 with respect to the remaining data input components 608, 610, and 612 as shown in FIG. 6B. In other aspects, the electronic device 600 may emphasize the data input component 606 by changing a color or a background of the data input component 606, changing a representation of the data input component 606, providing an audible feedback associated with the data input component 606, and/or providing a tactile feedback associated with the data input component 606. The emphasizing (e.g., enlargement) of the data input component 606 may serve as an indication to the user 618 that the data input component 606 is currently selected. A portion 620 of the data window 614 may also be emphasized (e.g., enlarged) to indicate the state of the data input component 606. The user 618 may then provide a second input to set the state of the data input component 606. In an aspect, the user 618 may provide the second input by touching the touchscreen display 602 on the data input component 606 as shown in FIG. 6C, and performing a swiping gesture downward (e.g., along the first direction) as shown in FIG. 6C. In another aspect, the user 618 may provide the second input by touching anywhere on the touchscreen display 602 and performing a swiping gesture downward (e.g., along the first direction) while the data input component 606 is emphasized (e.g., enlarged). In another aspect, the user 618 may provide the second input by tilting the touchscreen display 602 downward (e.g., towards the first direction). As shown in FIG. 6C, the electronic device 600 may scroll the states of the data input component 606 downward in response to the second input. For example, the user 618 may perform the swiping gesture until the desired state (e.g., the number four in this example) of the data input component 606 is set in the portion 620 of the data window 614. In an aspect, the user 618 may provide the second input by touching anywhere on the touchscreen display 602 and making a swiping gesture upward (e.g., along the third direction) while the data input component 606 is emphasized (e.g., enlarged). In another aspect, the user 618 may provide the second input by tilting the touchscreen display 602 upward (e.g., towards the third direction) while the data input component 606 is emphasized (e.g., enlarged). In such aspects, the electronic device 600 may scroll the states of the data input component 606 upward (e.g., along the third direction) in response to the second input.

When the desired value is set in the portion 620 of the data window 614, the user 618 may provide a third input to select a different data input component. In an aspect, with reference to FIG. 6D, the user 618 may provide the third input by touching the touchscreen display 602 on or near the data input component 606 while the data input component 606 is emphasized (e.g., enlarged), and making a swiping gesture in a horizontal direction (e.g., along the second direction). In an aspect, the user 618 may provide the third input by touching anywhere on the touchscreen display 602 and performing a swiping gesture in a horizontal direction (e.g., along the second direction) while the data input component 606 is emphasized (e.g., enlarged). In another aspect, the user 618 may provide the third input by tilting the touchscreen display 602 in a horizontal direction (e.g., towards the second direction) while the data input component 606 is emphasized (e.g., enlarged). In response to the third input, the electronic device 600 may emphasize (e.g., enlarge) a data input component that is adjacent to the data input component 606, such as the data input component 608 as shown in FIG. 6E. A portion 622 of the data window 614 may also be emphasized (e.g., enlarged) to indicate the state of the data input component 608. The user 618 may then provide a fourth input to set the state of the data input component 608. In an aspect, the user 618 may provide the fourth input by touching the touchscreen display 602 and performing a swiping gesture in the first or third direction similar to the manner in which the state of data input component 606 may be set. In another aspect, the user 618 may provide the fourth input by tilting the touchscreen display 602 in the first or third direction similar to the manner in which the state of data input component 606 may be set. In an aspect, the user 618 may perform a swiping gesture along the fourth direction or may tilt the touchscreen display 602 towards the fourth direction while the data input component 606 is emphasized (e.g., enlarged) to reselect the data input component 606.

When the user 618 has completed setting the state of each data input component 606, 608, 610, and 612, the user 618 may submit (e.g., confirm or enter) the value that appears in the data window 614 by providing a fifth input. In an aspect, the fifth input may be an action performed on the electronic device 600 and the value that appears in the data window 614 may be submitted in response to the performed action. In an aspect, the action may include a shaking motion performed on the electronic device 600, a circular swiping gesture (or other gesture) performed anywhere on the touchscreen display 602, a voice command from the user 618, or a combination thereof.

Therefore, since the area of the touchscreen display 602 is small relative to the size of a finger of the user, the electronic device 600 emphasizes (e.g., enlarges) a selected data input component to facilitate setting of the selected data input component. For example, and as previously discussed, the electronic device 600 may enlarge data input component 606 selected by the user, and the user may efficiently set the enlarged data input component 606 without inadvertently selecting and/or setting other data input components (e.g., data input components 608, 610, and/or 612) of the data entry interface 604.

### Exemplary Starting Configurations of Data Input Components—Interactive Wheels

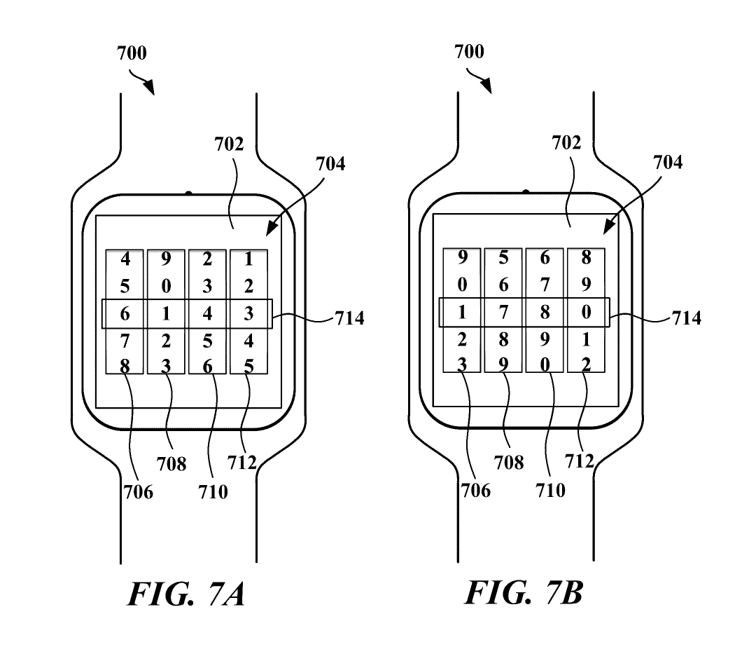

FIG. 7 (including FIGS. 7A and 7B) illustrates an exemplary electronic device 700 in accordance with various aspects of the disclosure. In an aspect, the electronic device 700 may correspond to the electronic device 600 in FIG. 6. As shown in FIG. 7A, electronic device 700 includes a touchscreen display 702 configured to display a data entry interface 704 that may be similar in operation to the previously discussed data entry interface 604 in FIG. 6.

In an aspect, the electronic device 700 may display the data entry interface 704 for a first user according to a first starting configuration (e.g., the number “6143” in data window 714) of the data input components 706, 708, 710, and 712 shown in FIG. 7A. In an aspect, the first starting configuration of the data input components 706, 708, 710, and 712 may be randomly generated by the electronic device 700 and may be associated with an account identifier of the first user. In such aspect, the electronic device 700 may receive a valid account identifier from the first user and may display the data input components 706, 708, 710, and 712 according to the first starting configuration shown in FIG. 7A every time the first user provides the valid account identifier. In an aspect, the first starting configuration may be independent of a second starting configuration associated with a different account identifier. For example, with reference to FIG. 7B, a second starting configuration (e.g., the number “1780” in data window 714) of the data input components 706, 708, 710, and 712 may be randomly generated by the electronic device 700 and may be associated with an account identifier of the second user. In such aspect, the electronic device 700 may receive a valid account identifier from the second user and may display the data input components 706, 708, 710, and 712 according to the second starting configuration shown in FIG. 7B every time the second user provides the valid account identifier. In the aspect of FIG. 7, the first starting configuration of the data input components 706, 708, 710, and 712 shown in FIG. 7A is different from the second starting configuration of the data input components 706, 708, 710, and 712 shown in FIG. 5B. Therefore, by displaying the data input components according to different starting configurations for different users, phishing attacks may be avoided. In other words, the different starting configurations for different users make it difficult for unauthorized third parties to determine the states of the data input components set by each user. In other aspects, the first starting configuration of the data input components 706, 708, 710, and 712 shown in FIG. 7A may be the same as the second starting configuration of the data input components 706, 708, 710, and 712 shown in FIG. 7B.

### Exemplary Electronic Device and Method Thereon

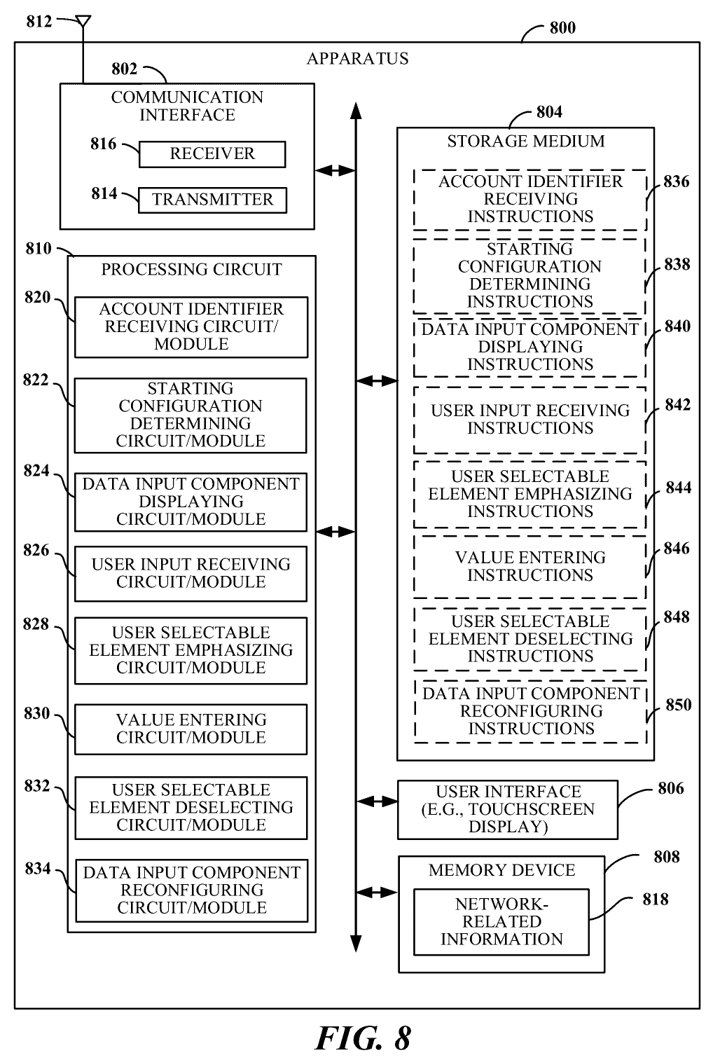

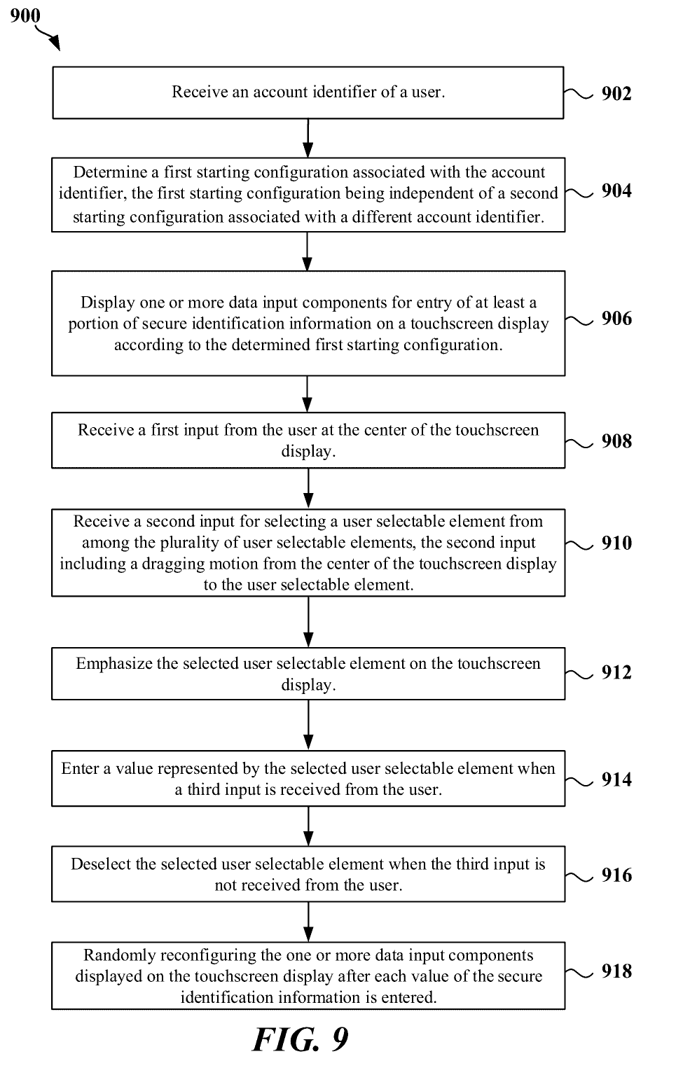

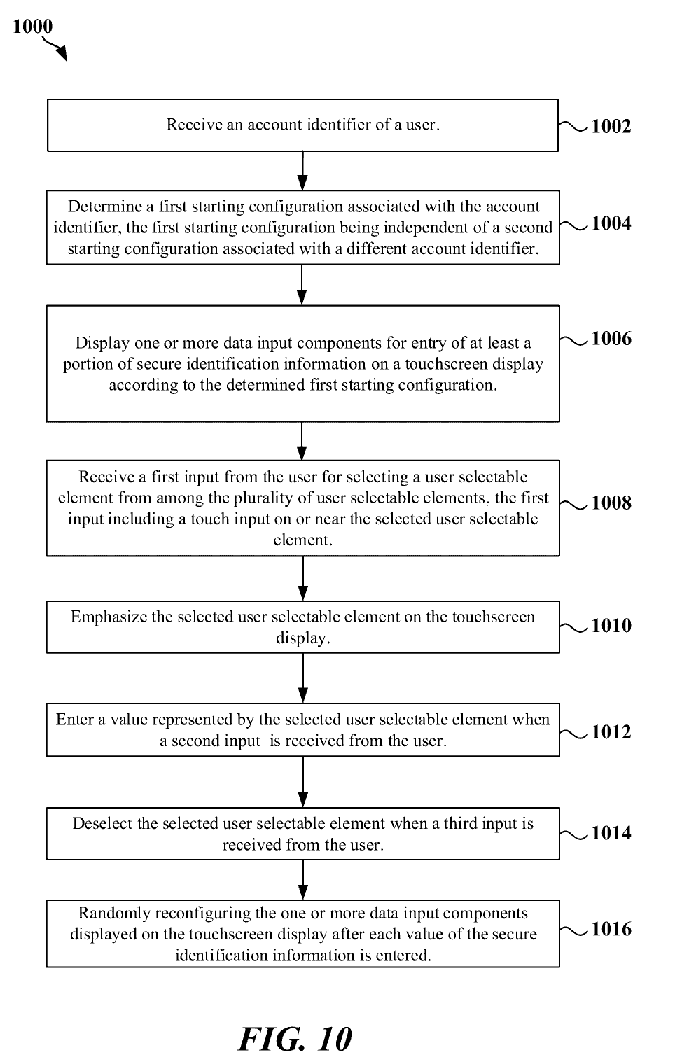

FIG. 8 is an illustration of an apparatus 800 configured to support operations related to secure identification information entry on a small touchscreen display according to one or more aspects of the disclosure (e.g., aspects related to the methods of FIGS. 9, 10, and/or 11 described below). The apparatus 800 includes a communication interface (e.g., at least one transceiver) 802, a storage medium 804, a user interface (e.g., touchscreen display) 806, a memory device 808, and a processing circuit 810.

These components can be coupled to and/or placed in electrical communication with one another via a signaling bus or other suitable component, represented generally by the connection lines in FIG. 8. The signaling bus may include any number of interconnecting buses and bridges depending on the specific application of the processing circuit 810 and the overall design constraints. The signaling bus links together various circuits such that each of the communication interface 802, the storage medium 804, the user interface 806, and the memory device 808 are coupled to and/or in electrical communication with the processing circuit 810. The signaling bus may also link various other circuits (not shown) such as timing sources, peripherals, voltage regulators, and power management circuits, which are well known in the art, and therefore, will not be described any further.

The communication interface 802 may be adapted to facilitate wireless communication of the apparatus 800. For example, the communication interface 802 may include circuitry and/or code (e.g., instructions) adapted to facilitate the communication of information bi-directionally with respect to one or more communication devices in a network. The communication interface 802 may be coupled to one or more antennas 812 for wireless communication within a wireless communication system. The communication interface 802 can be configured with one or more standalone receivers and/or transmitters, as well as one or more transceivers. In the illustrated example, the communication interface 802 includes a transmitter 814 and a receiver 816.

The memory device 808 may represent one or more memory devices. As indicated, the memory device 808 may maintain network-related information/along with other information used by the apparatus 800. In some implementations, the memory device 808 and the storage medium 804 are implemented as a common memory component. The memory device 808 may also be used for storing data that is manipulated by the processing circuit 810 or some other component of the apparatus 800.

The storage medium 804 may represent one or more computer-readable, machine-readable, and/or processor-readable devices for storing code, such as processor executable code or instructions (e.g., software, firmware), electronic data, databases, or other digital information. The storage medium 804 may also be used for storing data that is manipulated by the processing circuit 810 when executing code. The storage medium 804 may be any available media that can be accessed by a general purpose or special purpose processor, including portable or fixed storage devices, optical storage devices, and various other mediums capable of storing, containing or carrying code.

By way of example and not limitation, the storage medium 804 may include a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing code that may be accessed and read by a computer. The storage medium 804 may be embodied in an article of manufacture (e.g., a computer program product). By way of example, a computer program product may include a computer-readable medium in packaging materials. In view of the above, in some implementations, the storage medium 804 may be a non-transitory (e.g., tangible) storage medium.

The storage medium 804 may be coupled to the processing circuit 810 such that the processing circuit 810 can read information from, and write information to, the storage medium 804. That is, the storage medium 804 can be coupled to the processing circuit 810 so that the storage medium 804 is at least accessible by the processing circuit 810, including examples where at least one storage medium is integral to the processing circuit 810 and/or examples where at least one storage medium is separate from the processing circuit 810 (e.g., resident in the apparatus 800, external to the apparatus 800, distributed across multiple entities, etc.).

Code and/or instructions stored by the storage medium 804, when executed by the processing circuit 810, causes the processing circuit 810 to perform one or more of the various functions and/or process operations described herein. For example, the storage medium 804 may include operations configured for regulating operations at one or more hardware blocks of the processing circuit 810, as well as to utilize the communication interface 802 for wireless communication utilizing their respective communication protocols.

The processing circuit 810 is generally adapted for processing, including the execution of such code/instructions stored on the storage medium 804. As used herein, the term “code” or “instructions” shall be construed broadly to include without limitation programming, instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The processing circuit 810 is arranged to obtain, process and/or send data, control data access and storage, issue commands, and control other desired operations. The processing circuit 810 may include circuitry configured to implement desired code provided by appropriate media in at least one example. For example, the processing circuit 810 may be implemented as one or more processors, one or more controllers, and/or other structure configured to execute executable code. Examples of the processing circuit 810 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 810 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 810 are for illustration and other suitable configurations within the scope of the disclosure are also contemplated.

According to one or more aspects of the disclosure, the processing circuit 810 may be adapted to perform any or all of the features, processes, functions, operations and/or routines for any or all of the apparatuses described herein. As used herein, the term “adapted” in relation to the processing circuit 810 may refer to the processing circuit 810 being one or more of configured, employed, implemented, and/or programmed to perform a particular process, function, operation and/or routine according to various features described herein.

According to at least one example of the apparatus 800, the processing circuit 810 may include one or more of an account identifier receiving circuit/module 820, a starting configuration determining circuit/module 822, a data input component displaying circuit/module 824, a user input receiving circuit/module 826, a user selectable element emphasizing circuit/module 828, a value entering circuit/module 830, a user selectable element deselecting circuit/module 832, and a data input component reconfiguring circuit/module 834 that are adapted to perform any or all of the features, processes, functions, operations and/or routines described herein (e.g., features, processes, functions, operations and/or routines described with respect to FIGS. 9, 10, and/or 11).

The account identifier receiving circuit/module 820 may include circuitry and/or instructions (e.g., account identifier receiving instructions 836 stored on the storage medium 804) adapted to perform several functions relating to, for example, receiving an account identifier of a user.

The starting configuration determining circuit/module 822 may include circuitry and/or instructions (e.g., starting configuration determining instructions 838 stored on the storage medium 804) adapted to perform several functions relating to, for example, determining a first starting configuration associated with an account identifier, the first starting configuration being independent of a second starting configuration associated with a different account identifier.

The data input component displaying circuit/module 824 may include circuitry and/or instructions (e.g., data input component displaying instructions 840 stored on the storage medium 804) adapted to perform several functions relating to, for example, displaying one or more data input components for entry of at least a portion of secure identification information (e.g., a PIN) on a touchscreen display according to the determined first starting configuration.

The user input receiving circuit/module 826 may include circuitry and/or instructions (e.g., user input receiving instructions 842 stored on the storage medium 1104) adapted to perform several functions relating to, for example, receiving an input from the user at the center of the touchscreen display, receiving an input for selecting a user selectable element from among the plurality of user selectable elements, the input including a dragging motion from the center of the touchscreen display to the user selectable element, receiving an input from the user for selecting a user selectable element from among the plurality of user selectable elements, the input including a touch input on or near the selected user selectable element, receiving an input from the user for selecting a data input component from among the one or more data input components, the data input component having a plurality of user selectable states, receiving an input from the user for modifying a state of the selected data input component, receiving an input from the user for selecting a different data input component displayed on the touchscreen display, and/or receiving an input from the user for modifying a state of the selected different data input component.

The user selectable element emphasizing circuit/module 828 may include circuitry and/or instructions (e.g., user selectable element emphasizing instructions 844 stored on the storage medium 804) adapted to perform several functions relating to, for example, emphasizing the selected user selectable element on the touchscreen display and/or emphasizing the selected data input component. For example, the emphasizing may include enlarging a size, changing a color or a background, changing a representation, providing an audible feedback, and/or providing a tactile feedback.

The value entering circuit/module 830 may include circuitry and/or instructions (e.g., value entering instructions 846 stored on the storage medium 804) adapted to perform several functions relating to, for example, entering a value represented by the selected user selectable element when an input is received from the user.

The user selectable element deselecting circuit/module 832 may include circuitry and/or instructions (e.g., user selectable element deselecting instructions 848 stored on the storage medium 804) adapted to perform several functions relating to, for example, deselecting the selected user selectable element when an input (e.g., release of touch on touchscreen display) is not received from the user and/or deselecting the selected user selectable element when an input (e.g., dragging gesture toward center of touchscreen display) is received from the user.

The data input component reconfiguring circuit/module 834 may include circuitry and/or instructions (e.g., data input component reconfiguring instructions 850 stored on the storage medium 804) adapted to perform several functions relating to, for example, randomly reconfiguring the one or more data input components displayed on the touchscreen display after each value of the secure identification information (e.g., each number of a PIN) is entered.

As mentioned above, instructions stored by the storage medium 804, when executed by the processing circuit 810, causes the processing circuit 810 to perform one or more of the various functions and/or process operations described herein. For example, the storage medium 804 may include one or more of the account identifier receiving instructions 836, the starting configuration determining instructions 838, the data input component displaying instructions 840, the user input receiving instructions 842, the user selectable element emphasizing instructions 844, the value entering instructions 846, the user selectable element deselecting instructions 848, and the data input component reconfiguring instructions 850.

FIG. 9 is a flowchart 900 illustrating a method of secure identification information entry on a small touchscreen display in accordance with various aspects of the disclosure. The method may be performed by an electronic device (e.g., electronic device 100 of FIG. 1 (including FIGS. 1A to 1I) or apparatus 800 of FIG. 8).

The electronic device receives an account identifier of a user 902. The electronic device determines a first starting configuration associated with the account identifier, the first starting configuration being independent of a second starting configuration associated with a different account identifier 904. The electronic device displays one or more data input components for entry of at least a portion of secure identification information (e.g., a PIN) on a touchscreen display according to the determined first starting configuration 906. In an aspect, each of the one or more data input components includes a number of user selectable elements in a circular arrangement. In an aspect, each of the number of user selectable elements represents an alphanumeric character, a pattern, a picture, a glyph, or a color. In an aspect, the first starting configuration is different from the second starting configuration.

The electronic device receives a first input from the user at the center of the touchscreen display 908. The electronic device receives a second input for selecting a user selectable element from among the number of user selectable elements, the second input including a dragging motion from the center of the touchscreen display to the user selectable element 910. The electronic device emphasizes the selected user selectable element on the touchscreen display 912. For example, the electronic device may emphasize the selected user selectable element by enlarging a size of the selected user selectable element, changing a color or a background of the selected user selectable element, changing a representation of the selected user selectable element, providing an audible feedback associated with the selected user selectable element, and/or providing a tactile feedback associated with the selected user selectable element. In an aspect, the electronic device enters a value represented by the selected user selectable element when a third input is received from the user 914. In an aspect, the electronic device deselects the selected user selectable element when the third input is not received from the user 916. In an aspect, the electronic device randomly reconfigures the one or more data input components displayed on the touchscreen display after each value of the secure identification information (e.g., each number of the PIN) is entered 918.

FIG. 10 is a flowchart 1000 illustrating a method of secure identification information entry on a small touchscreen display in accordance with various aspects of the disclosure. The method may be performed by an electronic device (e.g., electronic device 200 of FIG. 2 (including FIGS. 2A to 2K) or apparatus 800 of FIG. 8).

The electronic device receives an account identifier of a user 1002. The electronic device determines a first starting configuration associated with the account identifier, the first starting configuration being independent of a second starting configuration associated with a different account identifier 1004. The electronic device displays one or more data input components for entry of at least a portion of secure identification information (e.g., a PIN) on a touchscreen display according to the determined first starting configuration 1006. In an aspect, each of the one or more data input components includes a number of user selectable elements in a circular arrangement. In an aspect, each of the number of user selectable elements represents an alphanumeric character, a pattern, a picture, a glyph, or a color.

The electronic device receives a first input from the user for selecting a user selectable element from among the plurality of user selectable elements, the first input including a touch input on or near the selected user selectable element 1008. The electronic device emphasizes the selected user selectable element on the touchscreen display 1010. For example, the electronic device may emphasize the selected user selectable element by enlarging a size of the selected user selectable element, changing a color or a background of the selected user selectable element, changing a representation of the selected user selectable element, providing an audible feedback associated with the selected user selectable element, and/or providing a tactile feedback associated with the selected user selectable element. The electronic device enters a value represented by the selected user selectable element when a second input (e.g., tap or release) is received from the user 1012. The electronic device deselects the selected user selectable element when a third input (e.g., drag toward center) is received from the user 1014. The electronic device randomly reconfigures the one or more data input components displayed on the touchscreen display after each value of the secure identification information (e.g., each number of a PIN) is entered 1016.

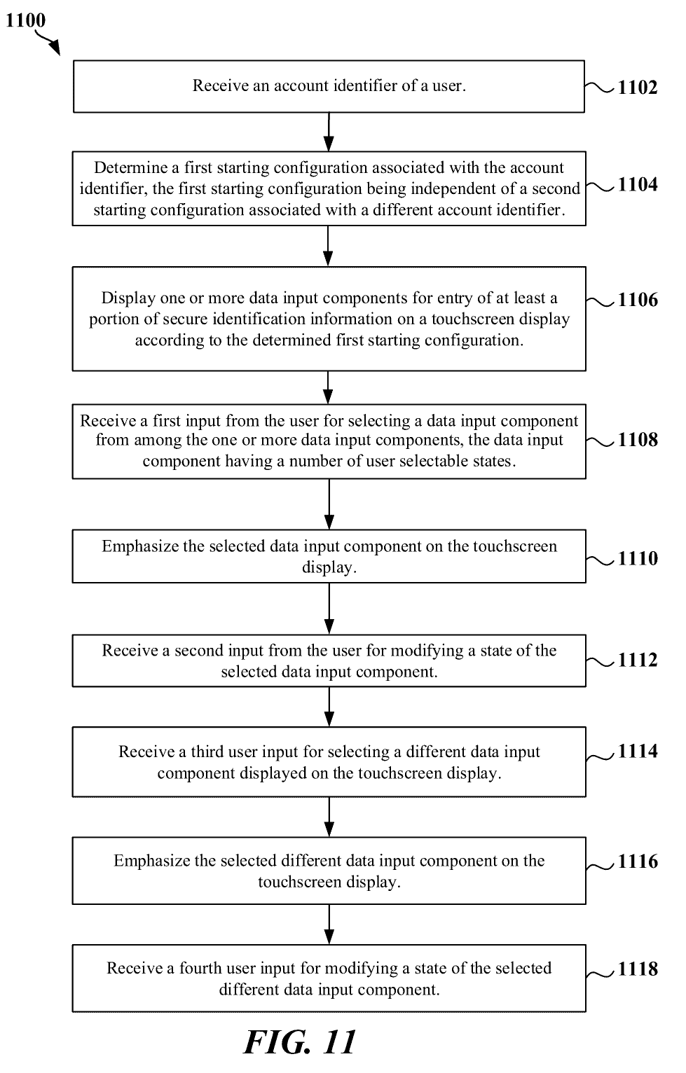

FIG. 11 is a flowchart 1100 illustrating a method of secure identification information entry on a small touchscreen display in accordance with various aspects of the disclosure. The method may be performed by an electronic device (e.g., electronic device 600 of FIG. 6 (including FIGS. 6A to 6E) or apparatus 800 of FIG. 8).

The electronic device receives an account identifier of a user 1102. The electronic device determines a first starting configuration associated with the account identifier, the first starting configuration being independent of a second starting configuration associated with a different account identifier 1104. The electronic device displays one or more data input components for entry of at least a portion of secure identification information (e.g., 1106) on a touchscreen display according to the determined first starting configuration 1106. The electronic device receives a first input from the user for selecting a data input component from among the one or more data input components, the data input component having a number of user selectable states 1108. The electronic device emphasizes (e.g., enlarges) the selected data input component on the touchscreen display 1110. The electronic device receives a second input from the user for modifying a state of the selected data input component 1112. The electronic device receives a third input from the user for selecting a different data input component displayed on the touchscreen display 1114. The electronic device emphasizes the selected different data input component on the touchscreen display 1116. For example, the electronic device may emphasize the selected different data input component by enlarging a size of the selected different data input component, changing a color or a background of the selected different data input component, changing a representation of the selected different data input component, providing an audible feedback associated with the selected different data input component, and/or providing a tactile feedback associated with the selected different data input component. The electronic device receives a fourth input from the user for modifying a state of the selected different data input component 1118. In an aspect, the first and third inputs are a swiping gesture in a first direction or a tilting motion in the first direction, and the second and fourth inputs are a swiping gesture in a second direction or a tilting motion in the second direction. For example, the first direction may be different from the second direction.

It is understood that the specific order or hierarchy of steps in the processes disclosed is an illustration of exemplary approaches. The specific order or hierarchy of steps in the processes may be rearranged based upon design preferences. The accompanying method claims present elements of the various steps in a sample order, and are not meant to be limited to the specific order or hierarchy presented.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computing device and/or distributed between two or more computing devices. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for an electronic device, comprising:
receiving an account identifier of a user;
determining a first starting configuration associated with the account identifier, the first starting configuration being independent of a second starting configuration associated with a different account identifier; and
displaying one or more data input components for entry of at least a portion of secure identification information on a touchscreen display according to the determined first starting configuration.

2. The method of claim 1, wherein each of the one or more data input components comprises a plurality of user selectable elements in a circular arrangement, and wherein each of the plurality of user selectable elements represents an alphanumeric character, a pattern, a picture, a glyph, or a color.

3. The method of claim 2, wherein the first starting configuration is different from the second starting configuration.

4. The method of claim 2, further comprising:
receiving a first input from the user at a center of the touchscreen display;
receiving a second input for selecting a user selectable element from among the plurality of user selectable elements, the second input including a dragging motion from the center of the touchscreen display to the user selectable element;
emphasizing the selected user selectable element on the touchscreen display;
entering a value represented by the selected user selectable element when a third input is received from the user; and
deselecting the selected user selectable element when the third input is not received from the user.

5. The method of claim 4, wherein emphasizing the selected user selectable element on the touchscreen display comprises at least one of enlarging a size of the selected user selectable element, changing a color or a background of the selected user selectable element, changing a representation of the selected user selectable element, providing an audible feedback associated with the selected user selectable element, or providing a tactile feedback associated with the selected user selectable element.

6. The method of claim 2, further comprising:
receiving a first input from the user for selecting a user selectable element from among the plurality of user selectable elements, the first input including a touch input on or near the selected user selectable element;
emphasizing the selected user selectable element on the touchscreen display;
entering a value represented by the selected user selectable element when a second input is received from the user; and
deselecting the selected user selectable element when a third input is received from the user.

7. The method of claim 1, further comprising randomly reconfiguring the one or more data input components displayed on the touchscreen display after each value of the secure identification information is entered.

8. The method of claim 2, wherein the plurality of user selectable elements represents a first sequence of numbers or letters that increases in a clockwise direction, or wherein the plurality of user selectable elements represents a second sequence of numbers or letters that decreases in the clockwise direction.

9. The method of claim 1, further comprising:
receiving a first input from the user for selecting a data input component from among the one or more data input components, the data input component having a plurality of user selectable states;
emphasizing the selected data input component on the touchscreen display; and
receiving a second input from the user for modifying a state of the selected data input component.

10. The method of claim 8, further comprising:
receiving a third input from the user for selecting a different data input component displayed on the touchscreen display;
emphasizing the selected different data input component on the touchscreen display; and
receiving a fourth input from the user for modifying a state of the selected different data input component.

11. The method of claim 9, wherein the first and third inputs are a swiping gesture in a first direction or a tilting motion in the first direction, and the second and fourth inputs are a swiping gesture in a second direction or a tilting motion in the second direction, and wherein the first direction is different from the second direction.

12. An electronic device, comprising:
a memory; and
a processing circuit coupled to the memory and configured to:
receive an account identifier of a user;
determine a first starting configuration associated with the account identifier, the first starting configuration being independent of a second starting configuration associated with a different account identifier; and
display one or more data input components for entry of at least a portion of secure identification information on a touchscreen display according to the determined first starting configuration.

13. The electronic device of claim 12, wherein each of the one or more data input components comprises a plurality of user selectable elements in a circular arrangement, and wherein each of the plurality of user selectable elements represents an alphanumeric character, a pattern, a picture, a glyph, or a color.

14. The electronic device of claim 13, wherein the processing circuit is further configured to:
receive a first input from the user at a center of the touchscreen display;
receive a second input for selecting a user selectable element from among the plurality of user selectable elements, the second input including a dragging motion from the center of the touchscreen display to the user selectable element;
emphasize the selected user selectable element on the touchscreen display;
enter a value represented by the selected user selectable element when a third input is received from the user; and
deselect the selected user selectable element when the third input is not received from the user.

15. The electronic device of claim 13, wherein the processing circuit is further configured to:
receive a first input from the user for selecting a user selectable element from among the plurality of user selectable elements, the first input including a touch input on or near the selected user selectable element;
emphasize the selected user selectable element on the touchscreen display;
enter a value represented by the selected user selectable element when a second input is received from the user; and
deselect the selected user selectable element when a third input is received from the user.

16. The electronic device of claim 12, wherein the processing circuit is further configured to:
randomly reconfigure the one or more data input components displayed on the touchscreen display after each value of the secure identification information is entered.

17. The electronic device of claim 13, wherein the plurality of user selectable elements represents a first sequence of numbers or letters that increases in a clockwise direction, or wherein the plurality of user selectable elements represents a second sequence of numbers or letters that decreases in the clockwise direction.

18. The electronic device of claim 12, wherein the processing circuit is further configured to:
receive a first input from the user for selecting a data input component from among the one or more data input components, the data input component having a plurality of user selectable states;
emphasize the selected data input component on the touchscreen display; and
receive a second input from the user for modifying a state of the selected data input component.

19. The electronic device of claim 18, wherein the processing circuit is further configured to:
receive a third input from the user for selecting a different data input component displayed on the touchscreen display;
emphasize the selected different data input component on the touchscreen display; and
receive a fourth input from the user for modifying a state of the selected different data input component.

20. The electronic device of claim 19, wherein the first and third inputs are a swiping gesture in a first direction or a tilting motion in the first direction, and the second and fourth inputs are a swiping gesture in a second direction or a tilting motion in the second direction, and wherein the first direction is different from the second direction.

21. An electronic device, comprising:
means for receiving an account identifier of a user;
means for determining a first starting configuration associated with the account identifier, the first starting configuration being independent of a second starting configuration associated with a different account identifier; and
means for displaying one or more data input components for entry of at least a portion of secure identification information on a touchscreen display according to the determined first starting configuration.

22. The electronic device of claim 21, wherein each of the one or more data input components comprises a plurality of user selectable elements in a circular arrangement, and wherein each of the plurality of user selectable elements represents an alphanumeric character, a pattern, a picture, a glyph, or a color.

23. The electronic device of claim 22, further comprising:
means for receiving a first input from the user at a center of the touchscreen display;
means for receiving a second input for selecting a user selectable element from among the plurality of user selectable elements, the second input including a dragging motion from the center of the touchscreen display to the user selectable element;
means for emphasizing the selected user selectable element on the touchscreen display;
means for entering a value represented by the selected user selectable element when a third input is received from the user; and
means for deselecting the selected user selectable element when the third input is not received from the user.

24. The electronic device of claim 22, further comprising:
means for receiving a first input from the user for selecting a user selectable element from among the plurality of user selectable elements, the first input including a touch input on or near the selected user selectable element;
means for emphasizing the selected user selectable element on the touchscreen display;
means for entering a value represented by the selected user selectable element when a second input is received from the user; and
means for deselecting the selected user selectable element when a third input is received from the user.

25. The electronic device of claim 21, further comprising:
means for receiving a first input from the user for selecting a data input component from among the one or more data input components, the data input component having a plurality of user selectable states;
means for emphasizing the selected data input component on the touchscreen display; and
means for receiving a second input from the user for modifying a state of the selected data input component.

26. The electronic device of claim 25, further comprising:
means for receiving a third input from the user for selecting a different data input component displayed on the touchscreen display;
means for emphasizing the selected different data input component on the touchscreen display; and
means for receiving a fourth input from the user for modifying a state of the selected different data input component.

27. A processor-readable medium having instructions stored thereon, which when executed by one or more processors causes the one or more processors to:
receive an account identifier of a user;
determine a first starting configuration associated with the account identifier, the first starting configuration being independent of a second starting configuration associated with a different account identifier; and
display one or more data input components for entry of at least a portion of secure identification information on a touchscreen display according to the determined first starting configuration.

28. The processor-readable medium of claim 27, wherein each of the one or more data input components comprises a plurality of user selectable elements in a circular arrangement, and wherein each of the plurality of user selectable elements represents an alphanumeric character, a pattern, a picture, a glyph, or a color.

29. The processor-readable medium of claim 28, further having instructions stored thereon, which when executed by one or more processors causes the one or more processors to:
receive a first input from the user at a center of the touchscreen display;
receive a second input for selecting a user selectable element from among the plurality of user selectable elements, the second input including a dragging motion from the center of the touchscreen display to the user selectable element;
emphasize the selected user selectable element on the touchscreen display;
enter a value represented by the selected user selectable element when a third input is received from the user; and
deselect the selected user selectable element when the third input is not received from the user.

30. The processor-readable medium of claim 28, further having instructions stored thereon, which when executed by one or more processors causes the one or more processors to:
receive a first input from the user for selecting a user selectable element from among the plurality of user selectable elements, the first input including a touch input on or near the selected user selectable element;
emphasize the selected user selectable element on the touchscreen display;
enter a value represented by the selected user selectable element when a second input is received from the user; and
deselect the selected user selectable element when a third input is received from the user.
